(19) United States
(12) Patent Application Publication
(10) Pub. No.: US 2010/0095841 A1
(43) Pub. Date: Apr. 22, 2010

(54) VSA gas concentrator using a reversing blower

(75) Inventor: Tarik Naheiri, Dana Point, CA (US)

Correspondence Address: BRADLEY P. HEISLER;HEISLER & ASSOCIATES, 3017 DOUGLAS BOULEVARD, SUTIE 300, ROSEVILLE, CA, 95661, US

(73) Assignee: Pacific Consolidated Industries, Inc.

(21) Appl. No.: 12/288,546

(22) Filed: Oct. 20, 2008

(51) Int. Cl. B01D 53/047; B01D 53/54

(52) U.S. Cl. 95/26; 96/143; 95/96

(57) ABSTRACT

The concentrator separates one gas (i.e. oxygen) from a gas mixture (i.e. air) through the process of vacuum swing adsorption (VSA). An adsorber material is located within an adsorber bed. The adsorber bed has an inlet and an outlet. A valve is located downstream of the outlet. A pump, such as a blower, is provided upstream of the adsorber bed to drive a mixed gas into the adsorber bed. The adsorber material selectively adsorbs an undesirable gas (i.e. nitrogen) leaving a desirable gas (i.e. oxygen) from the mixture to pass through the outlet and through the valve. The pump is reversible. When the adsorber material becomes saturated, the pump is reversed and a vacuum is drawn on the adsorber bed. The valve is closed while the pump is operating in this reverse direction. After the adsorber material has desorbed the undesirable gas, the pump again reverses and the cycle is repeated.

### FIELD OF THE INVENTION

The following invention relates to gas concentrators and gas separators for preferentially separating one gas from a mixture of different gases, such as collection of oxygen from air. More particularly, this invention relates to pressure swing adsorption and vacuum swing adsorption (“VSA,” which is a type of pressure swing adsorption, “PSA”) type gas separators.

### BACKGROUND OF THE INVENTION

When gases are combined they nearly always keep substantially homogeneous distribution within a confined space. Even unconfined spaces such as the atmosphere contain a substantially homogeneous mixture of gases. It is often desirable to have gases collected in pure or substantially pure form. One way to collect such gases is to separate them from a homogeneous mixture of gases where one desired gas is mixed with other gases. For instance, it is often desirable to have oxygen concentrated into a substantially pure form by separation of the oxygen from air.

Air in the atmosphere is a substantially homogeneous mixture of approximately 79% nitrogen, 20% oxygen and 1% argon. Air also includes water vapor to varying degrees depending on the humidity of the air. Air also includes a fraction of a percent of carbon dioxide and trace amounts of other gases such as hydrogen, helium, other noble gases and small trace amounts of gaseous compounds.

One known technique for separating oxygen from air (or separating other desirable gases from a gas mixture) is to take advantage of the different condensation points for different gases at which the gases condense into a liquid. Such “liquefaction” is particularly effective when the gases in the gas mixture have widely different condensation points, and particularly when at least one of the condensation points is near ambient temperature. For instance, a condenser for condensing water vapor out of air is effectively operated, often with little or no power input, to remove large portions of gaseous water (i.e. steam or water vapor) from air.

However, when gases to be separated have similar condensation temperatures or the condensation temperatures are significantly lower than ambient conditions, significant power and potentially elaborate machinery is required for effective gas separation. When oxygen is to be separated from air, such difficulties are encountered. Oxygen and nitrogen have quite similar condensation temperatures and these condensation temperatures are significantly lower than ambient conditions (i.e. −320.5° F. for nitrogen and −297.3° F. for oxygen). Thus, liquefaction for effective separation of oxygen from air requires significant power input and elaborate machinery, making such liquefaction undesirable in many instances.

A second technique widely used for air separation is membrane technology where a membrane is used to separate the gasses. Typically this method is used when the desired gas is nitrogen. It can also be used to provide oxygen, but generally is only used where nitrogen is the desired gas, because the oxygen produced using membrane technology is not as pure as is available with other technologies. In most cases where membrane technology is used, the Argon component of the air will stay with the nitrogen while the carbon dioxide and the water will stay with the oxygen.

Another technique for separating gases from a gas mixture is to utilize the unique properties of certain materials which preferentially adsorb one gas over another. For instance, it is known to utilize suitably sized molecular sieve materials as an adsorbent which preferentially adsorbs nitrogen over oxygen. When air is passed through a bed of such an adsorbent material, the nitrogen is adsorbed onto the surface of the adsorbent material. Remaining portions of the air are substantially entirely oxygen. Such adsorbent material also adsorbs carbon dioxide and water vapor. While argon is not typically adsorbed and so remains with the oxygen, oxygen can often be effectively utilized even when the argon from the original air gas mixture is still present.

Such pressure swing adsorption systems can be divided into two general types including pressure swing adsorption (PSA) and vacuum swing adsorption (VSA). The primary difference between PSA and VSA is the pressure at which the adsorber material is caused to desorb the gaseous molecules or compounds which had previously adsorbed to refresh the adsorber material. With PSA, adsorption occurs at a pressure above atmospheric pressure and desorption occurs at a lower pressure, typically at or near atmospheric pressure. With VSA, adsorption occurs at or above atmospheric pressure and desorption occurs below atmospheric pressure in at least a partial vacuum.

Prior art VSA systems known in commercial use are typified by systems such as that provided by Praxair of Danbury, Conn.; Airproducts of Allentown, Pa. and others, and systems such as those described in U.S. Pat. No. 4,661,124. In such systems, typically one or more adsorption beds are provided. Often two beds are used. In a two bed system one bed adsorbs the nitrogen and other undesirable gasses the other will be in the desorb (refresh) process The simplest example of current art is the case of a single bed VSA system. In these single bed systems the blower rotates in one direction. Air is fed to the bed from the pressure side of the blower. When the bed is saturated with nitrogen, valves are then actuated to change the inlet of the bed from the outlet side of the blower to the inlet side of the blower. Thus the same blower charges the bed with process air and creates the vacuum to desorb the bed. In each pressure swing system, (PSA and VSA), a buffer tank is usually included so that a constant supply of oxygen can be provided.

One problem with such prior art VSA systems is that they require valves and plumbing of non-trivial complexity. These various parts not only take up additional space, but also add to complexity and weight of such systems. Their complexity also results in higher than needed power consumption. It is desirable to provide VSA systems which can be compact and lightweight to make such systems more readily portable to enhance the usefulness of such systems.

### SUMMARY OF THE INVENTION

With this invention a vacuum swing adsorption (VSA) gas concentrator is provided for separating a desired gas from a gas mixture. The gas concentrator includes a single adsorber bed in a simplest form of the invention rather than the two or more adsorber beds of typical prior art VSA gas concentrator systems. The adsorber bed has an inlet spaced from an outlet. The adsorber bed is located within an enclosure which is isolated from a surrounding environment. A valve is located downstream of the adsorber bed outlet. This valve can be selectively opened and closed by a controller. A pump is located upstream of the inlet of the adsorber bed. This pump defines the sole pump of the system. This pump is reversible so that it can both drive a gas mixture into the adsorber bed to the inlet and pull a vacuum on the adsorber bed to pull the adsorbed gas out of the adsorber material within the adsorber bed and pull this adsorbed gas out of the system. A simplest form of the invention uses the same opening to act as the inlet for the gas mixture and the outlet for the undesirable adsorbed gas or gases.

When the VSA gas concentrator of this invention is configured for separation of oxygen from air, the adsorber and the adsorber bed is configured to preferentially adsorb nitrogen, carbon dioxide and water, as well as other undesirable contaminate gases within the air. Oxygen and argon are less preferentially adsorbed and so flow out of the adsorber enclosure through the outlet when the valve is open. When the adsorber bed starts to have the adsorber therein become saturated with nitrogen and other adsorbed gases, the pump is reversed and caused to pull a vacuum on the adsorber enclosure.

In a preferred form of the invention the valve between the buffer tank and the adsorber bed is closed at the beginning of the vacuum cycle. As the vacuum portion of the cycle comes to a close, the valve is opened for a short period of time so that oxygen can purge the adsorber enclosure to some extent. After this partial vacuum drawn on the adsorber bed has removed a sufficient quantity of the adsorbed gases that the adsorber material is recharged and ready to adsorb nitrogen and other gases again, the pump is again reversed and caused to draw air into the adsorber bed.

As the process proceeds the cycle continues to deliver oxygen or other preferred gases through the system. These preferred gases are preferably supplied to a buffer tank which can store the preferred gas for later use. The buffer tank is potentially also available to feed back a small amount of preferred gas for purging of the adsorber enclosure shortly after the pump reverses flow to go into the desorption mode.

### OBJECTS OF THE INVENTION

Accordingly, a primary object of the present invention is to provide a system for concentrating at least one gas from a gas mixture by preferentially adsorbing at least one undesirable gas within the gas mixture.

Another object of the present invention is to provide a gas separator which can separate different gases from each other by preferential adsorption of at least one of the gases.

Another object of the present invention is to provide a method for separating one gas at least partially from another gas within a gas mixture through utilization of an adsorber material which preferentially adsorbs one of the gases over other gases in the gas mixture.

Another object of the present invention is to provide a gas separator which is compact and lightweight in form.

Another object of the present invention is to provide a gas separator which is of simple operation and simple configuration with a small number of parts.

Another object of the present invention is to provide a system for delivering oxygen on demand by separating the oxygen from air.

Another object of the present invention is to provide a vacuum swing adsorption system which utilizes a single adsorbent bed and a single pump to simplify the VSA system.

Another object of the present invention is to separate gases using the molecular sieve vacuum swing adsorption process using a reversing compressor/blower.

Other further objects of the present invention will become apparent from a careful reading of the included drawing figures, the claims and detailed description of the invention.

### BRIEF DESCRIPTION OF THE DRAWINGS

FIG. 1 is a schematic view of the system of this invention illustrating the flow of air into the system and oxygen and nitrogen out of the system when operating according to a preferred embodiment of this invention.

### DESCRIPTION OF THE PREFERRED EMBODIMENT

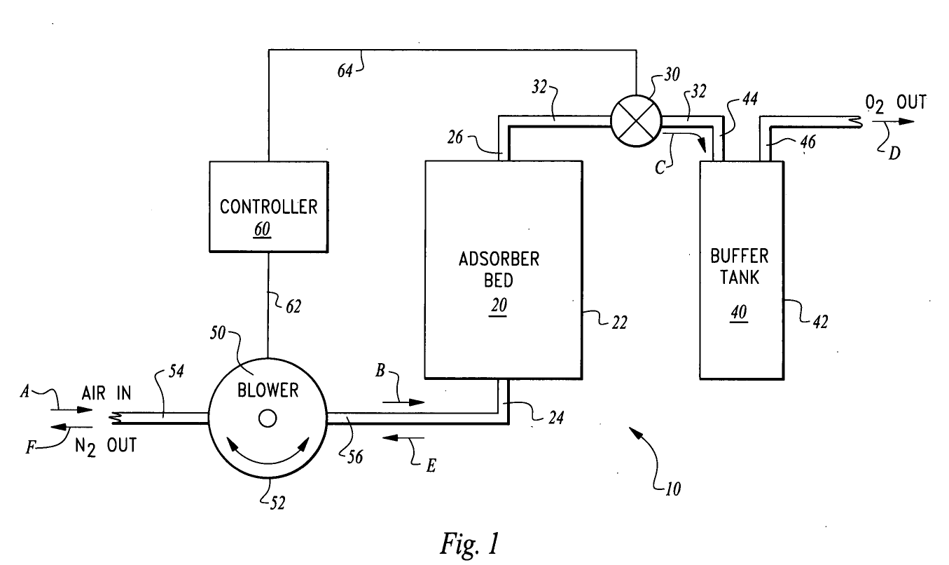

Referring to the drawings, wherein like reference numerals represent like parts throughout the various drawing figures, reference numeral 10 (FIG. 1) is directed to an oxygen separator configured to separate/concentrate oxygen from air in a preferred embodiment of this invention. While the invention is illustrated in this embodiment as being configured to separate oxygen from air, through this selection of an appropriate adsorbent material other gases could be preferentially separated from gas mixtures utilizing the same or an appropriately modified system.

In essence, and with particular reference to FIG. 1, basic details of the oxygen separator 10 described in the preferred embodiment of this invention are disclosed. The oxygen separator 10 includes an adsorber bed 20 including an adsorber material therein which preferentially adsorbs nitrogen, CO2 and water over oxygen. A valve 30 is located downstream of the adsorber bed 20. A buffer tank 40 is provided downstream of the valve 30. A blower 50 defines a preferred form of pump located upstream of the adsorber bed 20. A controller 60 is coupled to the valve 30 and the blower 50 (or other pump) to control opening and closing of the valve 30 and to control a direction in which the blower 50 (or other pump) is operating, to either provide air into the adsorber bed 20 or pull a vacuum to desorb and remove nitrogen out of the adsorber bed 20. Normally, a heat exchanger is required between the blower and the adsorber bed to remove the heat generated when the air is compressed. The heat exchanger may be bypassed during the vacuum phase of the cycle.

With continuing reference to FIG. 1, details of the adsorber bed 20 are described according to this preferred embodiment. The adsorber bed 20 includes an enclosure 22 for containing the adsorber material. This enclosure 22 includes an inlet 24 spaced from an outlet 26. The inlet 24 and outlet 26 define preferred forms of first and second ports for access into the enclosure 22. The inlet 24 and outlet 26 normally are incorporated in closures or “end plates” which can be removed to allow access to the adsorption components in the enclosure 22. Otherwise, the enclosure 22 is preferably sealed to prevent leakage of gases into or out of the enclosure 22.

The adsorber material within the adsorber bed 20 could be any form of material which preferentially adsorbs nitrogen over oxygen. One such material is molecular sieve such as nitroxy siliporite. This material is preferably supplied in the form of beads which are either generally spherical in form or can be of irregular shape. Since the beads are composed of molecular sieve material within the enclosure 22, gaseous pathways extend through, between and around the adsorbent material.

Most preferably, a plenum is configured at the inlet and the outlet end of the adsorber bed to provide even gas flow across the cross section of the bed. In a preferred configuration, the inlet 24 is located below the outlet 26, and with the inlet 24 at a lowermost portion of the enclosure 22 and the outlet 26 on an uppermost portion of the enclosure 22. The enclosure 22 could have a variety of different shapes. In one embodiment, the enclosure 22 could be generally rectangularly shaped. The enclosure could be shaped like a pressure vessel to maximize an amount of vacuum to be drawn on the enclosure 22 while minimizing an amount of material strength (i.e. wall thickness or material choice) that must be designed into the enclosure 22. If the size of the adsorber material is sufficiently small to potentially pass through the inlet 24 or outlet 26, filters are provided at the inlet 24 and outlet 26 to keep the adsorbent material within the enclosure 22.

With continuing reference to FIG. 1, details of the valve 30 are described. The valve 30 is interposed on a line 32 extending from the outlet 26 of the adsorber bed 20 and extending to the buffer tank 40. This line 32 is preferably substantially rigid, especially between the valve 30 and adsorber bed 20, so that when a vacuum is drawn on the adsorber bed 20, the line 32 does not collapse. The valve 30 is preferably sealed to prevent leakage in any manner when in a closed position and to only allow passage of gas along the line 32 when in an open position.

The valve 30 is preferably coupled to a controller 60 which controls the opening and closing of the valve 30. Optionally, the valve 30 could have a controller built into the valve 30 that could be set a single time and then operate in accordance with its settings.

While the valve 30 would typically be programmed once and then operate in accordance with such settings, the valve 30 could optionally be controlled at least partially through a control system including sensors and feedback to the valve 30. For instance, an oxygen sensor could be provided adjacent the valve 30 or along the line 32 between the valve 30 and the adsorber bed 20 to detect oxygen concentration levels approaching the valve 30. Nitrogen adjacent the valve 30 would be indicative that the adsorbent material within the adsorber bed 30 is saturated with nitrogen and that the oxygen separator 10 needs to change operating modes, to have the blower 50 (or other pump) reverse to pull a vacuum and desorb nitrogen from the adsorber material and pull the nitrogen out of the adsorber bed 20 to recharge the system.

Normally control of the cycle is achieved with the use of pressure transducers which reverse the blower at appropriate times. Usually the purge cycle is initiated when the vacuum reaches a certain predetermined level. The valve 30 is then opened for a predetermined amount of time so that a purge layer of oxygen is allowed to purge the remaining nitrogen from the bed. So the pressure and vacuum cycle are determined by pressure and the purge portion of the cycle is timed.

Other sensors could also potentially be utilized to allow the oxygen separator 10 to operate most effectively. The valve 30 is preferably of a type which operates with a minimum of lubricant or which can operate with a lubricant which is compatible with the handling of oxygen. The valve 30 and other portions of the oxygen separator 10 are also preferably formed of materials which are compatible with the handling of oxygen. For instance, brass is often effective in handling of oxygen and so brass is one material from which the valve 30 could be suitably manufactured when the system 10 is used for oxygen separation.

With continuing reference to FIG. 1, details of the buffer tank 40 are described according to a preferred embodiment. The buffer tank 40 is not strictly required for operation of this invention, but allows for the system in the form of the oxygen separator 10 to deliver oxygen substantially continuously, and to moderate pressure spikes in the system. The buffer tank 40 includes an enclosure 42 with an input 44 and an output 46 in FIG. 1. However, normally the buffer tank does not have a separate inlet and outlet. Since its purpose is simply to be an accumulator and minimize the pressure fluctuations inherent in the pressure swing adsorption process. The input 44 is coupled to the line 32 on a side of the valve 30 downstream from the adsorber bed 20.

The buffer tank 40 would typically have some form of regulator valve on the output 46 which would deliver oxygen out of the buffer tank 40 when oxygen is required by oxygen utilizing systems downstream of the buffer tank 40. The input 44 of the buffer tank 40 can remain in fluid communication with the valve 30. The buffer tank 40 can contain oxygen at above atmospheric pressure and at a pressure matching or slightly below an operating pressure of the adsorber bed 20 when the adsorber bed 20 is actively adsorbing nitrogen and oxygen flows into the buffer tank 40.

A sensor can be associated with the buffer tank 40 which cooperates with the controller 60 to shut off the oxygen separator 10 when the buffer tank 40 nears a full condition. In many applications a compressor is located downstream from the buffer tank 40 to fill oxygen vessels. When the vessels are full the system would be shut off. If required, a pressure regulator can also be provided on the output 46 of the buffer tank 40 so that pressure of oxygen supplied out of the buffer tank 40 remains substantially constant. Similarly, an oxygen pump could be provided downstream of the buffer tank 40 if the oxygen were required to be supplied at an elevated pressure above pressure within the buffer tank 40.

Most preferably, the buffer tank 40 is not a particularly high pressure tank so that the oxygen separator 10 including the blower 50 (or other pump) and adsorber bed 20 do not need to operate at a particularly high pressure when delivering oxygen to the buffer tank 40. By minimizing the pressure of the buffer tank 40, the weight of the buffer tank 40 (and other components of the system 10) can be significantly reduced. Furthermore, the power consumed by the blower is reduced as the pressure drop across the blower is reduced.

With continuing reference to FIG. 1, details of the blower 50 (or other pump) are described according to this preferred embodiment. This blower 50 generally includes a housing 52 with some form of prime mover therein coupled to a driver, such as an electric motor. The housing 52 of the blower 50 includes an entry 54 in direct access with a surrounding environment in a preferred embodiment of this invention. A discharge 56 is also provided on the housing 52 which is located on a side of the blower 50 closest to the adsorber bed 20.

The blower 50 is preferably in the form of a two or three lobed rotary blower coupled in direct drive fashion to an electric motor. In one embodiment the electric motor is a five horsepower three phase motor and the rotary blower is a two or three lobed blower and can deliver approximately one hundred cubic feet per minute when operating at atmospheric pressure. This rotary blower is also preferably configured to have acceptable performance when drawing a vacuum on the adsorber bed 20.

The lobes of the rotary blower are preferably configured so that they are of approximately similar efficiency in moving gases through the blower 50 between the entry 54 and the discharge 56 in either direction. In one form of the invention, the lobes are thus symmetrical in form so that they act on the air similarly in both directions of rotation for the blower 50.

The blower 50 is preferably substantially of a positive displacement type so that it maintains an adequate performance when drawing a vacuum on the adsorber bed 20 so that nitrogen can be effectively desorbed from the adsorber material in the adsorber bed 20 when the blower 50 is operating in a reverse direction to pull nitrogen out of the adsorber bed 20 and deliver the nitrogen out of the entry 54.

Most preferably, the blower 50 is coupled in direct drive fashion to the electric motor (or though a gear box). Most preferably, the electric motor is a three phase alternating current motor which can easily be reversed by reversing two of the phases. In this way, the controller 60 need merely reverse two poles of the three phase motor. In an other embodiment a direct current, permanent magnet may be used wherein the direction of the rotation can be reversed by reversing the polarity which in turn will reverse the rotation of the blower. Almost all three phase electric motors are capable of being reversed as above. Direct current motors are also readily available from many manufacturers which reverse their rotation direction by changing polarity.

Other types of pumps could alternatively be utilized for drawing air into the adsorber bed 20 and pulling nitrogen out of the adsorber bed 20 for the oxygen separator 10. For instance, such a pump could be a positive displacement pump, such as a piston pump or a peristaltic pump. Other forms of positive displacement pumps could also be utilized including gerotor pumps, gear pumps, etc. Other forms of pumps rather than strictly positive displacement pumps could also be selected, such as centrifugal pumps or axial flow pumps. The most efficient scheme for pumping the air into the system and exhausting the bed depends on the requirements of the final user.

With continuing reference to FIG. 1, details of the controller 60 are described, according to a preferred embodiment. The controller 60 is shown as a separate unit coupled to the blower 50 (or other pump) through a blower signal line 62 and coupled to the valve 30 through a valve signal line 64. The controller 60 could in fact be integrated into the valve 30 or integrated into the blower 50 (or other pump) or be provided as a standalone unit such as depicted in FIG. 1. It is also understood that the controller 60 could be split into two (or more) separate devices, either separate from the blower 50 and valve 30 or integrated into both the blower 50 and valve 30.

The controller 60 provides the basic function of controlling a direction in which the blower 50 is operating and whether the valve 30 is open or closed. Control systems have been used which simply time the cycle. More often, the controller is configured to react to pressure or some other input.

A preferred sequence for directional control of the blower 50 and opening and closing of the valve 30 are described in detail below. The controller 60 could be in the form of a programmable logic device or could be in the form of an application specific integrated circuit, or could be in the form of a CPU of a special purpose computer or a general purpose personal computer or other computing device. The controller 60 could be configured to have operating parameters set at a central controlled location, such as during manufacture, or could be configured to allow for programming in the field before and/or during operation.

In use and operation, and with particular reference to FIG. 1, details of the operation of the oxygen separator 10 of this invention are described. It will be understood that the invention would operate similarly when separating other gases than when separating oxygen from air, and the operation of this invention as an oxygen separator is provided merely as one example for this invention.

Initially, the system 10 is configured with the valve 30 closed and the blower 50 (or other pump) is caused to rotate in a direction driving gases out of the adsorber bed 20 (along arrow E). This is the vacuum cycle used to desorb nitrogen out of the beads in the bed 20. In particular, the blower 50 rotates to cause gases to be pulled into the entry 54 (along arrow E). This gas is removed from the bed 20 by the blower 50 and caused to pass through the discharge 54 away from the adsorber bed 20 along arrow F and to the surrounding atmosphere.

Nitrogen (or other undesirable gas) is adsorbed by the adsorber material within the adsorber bed 20. Most typically, the adsorber material also adsorbs water vapor and carbon dioxide, as well as potentially trace amounts of other gases, including pollutants.

During the last portion of the vacuum cycle valve 30 is opened to allow a small amount of the contents of the buffer tank to be introduced into the adsorber bed. This step is called the “purge phase.” The purge phase is used to purge nitrogen (as well as some carbon dioxide and water out of plumbing lines and free space between the valve 30 and the blower 50, but not appreciably out into the surrounding atmosphere. This short purge phase is typically timed to match an amount calculated or determined by experiment, but could also be ended based on sensor readings. This purge phase ends the vacuum cycle and precedes the adsorption cycle to follow.

The blower is then reversed to commence the adsorption cycle. Air is drawn into the blower at the inlet 54 port of the blower 50 (in the direction shown by arrow A). The air flows (along arrow B) into the adsorber bed 20 where nitrogen, carbon dioxide, and water are preferentially adsorbed. The gas not adsorbed in the adsorber bed (normally a mixture of oxygen and argon) is passed through valve 30 into the buffer tank 40.

The adsorber bed 20 might also adsorb oxygen to some extent. However, the adsorber material is selected so that it preferentially adsorbs nitrogen more than oxygen. Due to the presence of the adsorber material within the adsorber bed 20, substantially only oxygen (or other desirable gas) can leave the adsorber bed 20 through the outlet 26. Typically, argon also remains with the oxygen. Because air is approximately 1% argon and approximately 20% oxygen, this twenty to one ratio typically causes the gases being discharged from the adsorber bed 20 at the outlet 26 to be approximately 95% oxygen and 5% argon.

Because the valve 30 is opened, this oxygen can flow (along arrow C) through the valve 30 and into the buffer tank 40. The buffer tank 40 is thus charged with oxygen. If oxygen is desired, it can be discharged from the buffer tank 40 output 46 (along arrow D). The adsorber material within the adsorber bed 20 eventually becomes saturated with nitrogen and other compounds, such as water vapor and carbon dioxide. The point of such saturation can be calculated in advance and calibrated into the separator 10. Alternatively, a sensor can be provided, such as along the line 32 adjacent the valve 30, to sense for nitrogen or other contaminants within what should be substantially only oxygen and argon. Such a sensor can cause the system to detect such saturation of the adsorbent material within the adsorber bed 20 and thus change the mode of operation of the oxygen separator 10 from the adsorption cycle to the vacuum cycle. Other sensors to trigger the change could be pressure sensors or volumetric flow rater sensors either alone or in combination with a clock or a calibration table. The goal is to prevent nitrogen or other contaminates from passing the valve 30 after adsorption bed 20 saturation.

When such saturation has either been sensed as occurring or predicted to occur, the separator 10 changes operation modes by closing the valve 30. Then the blower 50 (or other pump) reverses its direction of operation. For instance, the controller 60 can reverse two of the three phases of a three phase electric motor coupled to the blower. The blower 50 is then caused to turn in an opposite direction and begins pulling gas (along arrow E) out of the adsorber bed 20 and into the blower 50 from the discharge 56 and out of the blower 50 through the entry 54 and out into a surrounding environment, as a repeat of the vacuum cycle described above.

The controller 60 can be programmed with a typical amount of time required to effectively desorb the nitrogen from the adsorbent material within the adsorber bed 20. Normally, the controller 60 senses a threshold low pressure in the adsorber bed 20. The system operation then continues as described above with a short purge phase followed by return to the desorption cycle.

This operating sequence for the oxygen separator 10 can repeat itself potentially indefinitely. When the buffer tank 40 becomes full (or vessels being filled from the buffer tank are full), an appropriate sensor associated with the buffer tank 40 can indicate that it is full and shut off the oxygen separator 10. As further amounts of oxygen are sensed as being needed, such as by a drop in pressure in the buffer tank 40, a signal can be sent to the controller 60 to again cause the system to commence operation.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

1. A gas concentrator, comprising in combination:
an adsorber enclosure;
an adsorber located within said adsorber enclosure;
said adsorber adapted to adsorb an undesirable gas preferentially over a desirable gas;
said adsorber enclosure having an inlet spaced from an outlet;
a valve located downstream of said outlet;
said valve adapted to be opened and closed;
a pump located upstream of said inlet; and
said pump adapted to reverse between pushing gas into said adsorber enclosure and pulling gas out of said adsorber enclosure.

2. The concentrator of claim 1 wherein said adsorber is adapted to adsorb nitrogen preferentially over oxygen.

3. The concentrator of claim 2 wherein said adsorber is in the form of solid beads.

4. The concentrator of claim 1 wherein said adsorber enclosure outlet is located above said adsorber enclosure inlet.

5. The concentrator of claim 1 wherein said valve is adapted to remain open for at least some time after said pump changes from pushing gas into said adsorber enclosure to pulling gas out of said adsorber enclosure.

6. The concentrator of claim 1 wherein said adsorber enclosure is adapted to operate with interior pressures below atmospheric pressure and sufficiently sealed to substantially prevent leakage into said adsorber enclosure other than through said inlet and said outlet.

7. The concentrator of claim 1 wherein a controller is coupled to said valve and said pump, said controller adapted to control a direction of said pump between pushing gas into said adsorber enclosure and pulling gas out of said adsorber enclosure and adapted to open and close said valve.

8. The concentrator of claim 1 wherein said pump includes a reversible pump coupled to a reversible electric motor.

9. The concentrator of claim 8 wherein said reversible electric motor includes a field coil, said field coil positioned to reverse a direction of rational output of said reversible electric motor when a direction of current flow through said field coil is reversed.

10. The concentrator of claim 1 wherein a buffer tank is located on a side of said valve opposite said adsorber enclosure.

11-17. (canceled)

18. A gas separator for at least partially separating a desired gas from an undesirable gas in a gas mixture, the gas separator comprising in combination:
an adsorber enclosure;
said adsorber enclosure containing an adsorber adapted to adsorb an undesirable gas preferentially over a desirable gas;
said adsorber enclosure having a first port spaced from a second port;
a valve coupled to said second port;
a means to move gas into said first port;
a means to reverse said gas moving means, such that gas is moved out of said first port;
wherein said gas moving means includes a reversible pump;
wherein said valve is adapted to close independent of reversal of said reversible pump; and
wherein a pressure sensor is located within said adsorber enclosure; and
a controller is coupled to said pump and said valve, said controller adapted to control said valve and said pump both responsive to adsorber enclosure internal pressure and time.

19. (canceled)

20. (canceled)

21. A gas concentrator, comprising in combination:
an adsorber enclosure;
an adsorber located within said adsorber enclosure;
said adsorber adapted to adsorb an undesirable gas preferentially over a desirable gas;
said adsorber enclosure having an inlet spaced from an outlet;
a valve located downstream of said outlet;
said valve adapted to be opened and closed;
a pump located upstream of said inlet;
said pump adapted to reverse between pushing gas into said adsorber enclosure and pulling gas out of said adsorber enclosure;
wherein a controller is coupled to said valve and said pump, said controller adapted to control a direction of said pump between pushing gas into said adsorber enclosure and pulling gas out of said adsorber enclosure and adapted to open and close said valve;
a pressure sensor located within said adsorber enclosure; and
said controller adapted to control. said valve and said pump both responsive to adsorber enclosure internal pressure and time.

22. The concentrator of claim 21 wherein said controller is adapted to cause said pump to pull gas out of said adsorber enclosure until said pressure sensor senses a preselected low pressure threshold, and then continues to pull gas out of said adsorber enclosure for a preselected purge time, with said controller adapted to open said valve during said purge time to allow gas from said outlet to flow back into said adsorber enclosure and gas in said adsorber enclosure to be purged out of said adsorber enclosure through said inlet, such that said gas in said adsorber enclosure can be purged and discouraged from passing from said adsorber enclosure through said outlet.

23. The concentrator of claim 21 wherein a buffer tank is located on a side of said valve opposite said adsorber enclosure, said buffer tank including a pressure regulator thereon, said pressure regulator coupled to said controller, said controller adapted to cause said pump to cease operation when a threshold high pressure of preselected value is sensed by said buffer tank pressure regulator.

24. The concentrator of claim 21 wherein said controller is adapted to control a direction of movement of the gas through said pump by interposing an electric motor between said controller and said pump, said electric motor being a three phase electric motor, said three phase electric motor configured to have two of said three phases reversed by said controller to reverse direction of rotation of said electric motor and reverse a direction of operation of said pump.

25. The concentrator of claim 18 wherein said controller is adapted to cause said pump to pull gas out of said adsorber enclosure until said pressure sensor senses a preselected low pressure threshold within said adsorber enclosure, and then continues to pull gas out of said adsorber enclosure for a preselected purge time, with said controller adapted to open said valve during said purge time to allow gas from said outlet to flow back into said adsorber enclosure and gas in said adsorber enclosure to be purged out of said adsorber enclosure through said inlet, such that said gas in said adsorber enclosure can be purged and discouraged from passing from said adsorber enclosure through said outlet.

26. The concentrator of claim 25 wherein a buffer tank is located on a side of said valve opposite said adsorber enclosure, said buffer tank including a pressure regulator thereon, said pressure regulator coupled to said controller, said controller adapted to cause said pump to cease operation when a threshold high pressure of preselected value is sensed by said buffer tank pressure regulator.

27. The concentrator of claim 26 wherein said controller is adapted to control a direction of movement of the gas through said pump by interposing an electric motor between said controller and said pump, said electric motor being a three phase electric motor, said three phase electric motor configured to have two of said three phases reversed by said controller to reverse direction of rotation of said electric motor and reverse a direction of operation of said pump.
